(19) United States
(12) Patent Application Publication
(10) Pub. No.: US 2024/0173106 A1
(43) Pub. Date: May 30, 2024

(54) Dental Implants with Internal Conical and Morse Taper Connections

(71) Applicant: Gerald A. Niznick, Las Vegas, NV (US)

(72) Inventor: Gerald A. Niznick, Las Vegas, NV (US)

(21) Appl. No.: 18/070,392

(22) Filed: Nov. 28, 2022

(51) Int. Cl. A61C 8/00

(52) U.S. Cl. CPC A61C 8/0071; A61C 8/0068; A61C 8/0074

(57) ABSTRACT

A dental implant includes an internal passage/shaft extending down from the top of the implant with a connection structure that includes, at/near the opening into the internal passage, a lead-in bevel configured for insertion of a post, abutment, or other insert, into the passage, below the lead-in bevel, inside the passage, an internal wrench-engaging surface; and, below the internal wrench-engaging surface, inside the passage, another beveled portion, inside the implant, configured to mate with the insert/abutment/post, to form an interference fit.

### SUMMARY OF INVENTION

A dental implant includes an externally threaded, partially threaded, or unthreaded body portion, and an internal passage that includes, near the opening into said passage, a lead-in bevel, configured to accept insertion, into the internal passage, of a post/abutment/other insert with a bevel.

Below the lead-in bevel is a wrench-engaging surface, and, below the wrench engaging surface, a second beveled surface having a bevel angle substantially smaller than the lead-in bevel.

The second bevel is preferably configured to accept a post/abutment/other insert having a straight or beveled extension of sufficient in size and shape, to form an interference fit, at that location, between the implant and the post/abutment/other insert. Below the second beveled surface is a threaded passage portion configured to engage the threaded shank of a 1-piece abutment, or a fixation screw used to retain a 2-piece abutment atop the implant.

Some embodiments of the new dental implant include an internal passage/shaft extending down from the top of the implant with a connection structure that includes, at the opening into the internal passage, a lead-in bevel. Insertion into the implant's internal passage of a post/abutment/other insert with a bevel about 1 degree larger than the implant's lead-in bevel, as measured from the implant's vertical centerline, provides implant/insert contact primarily at the opening to the internal shaft. Such a mating interface provides a minimal surface area for frictional retention, but still provides lateral stability and a sealed junction. The internal lead-in bevel can extend down from the opening, preferably over a length of about 0.5 mm to about 2.0 mm.

The passage/shaft extends inside the implant a vertical distance of about 5 to about 10 mm, and may be threaded to accept a one-piece healing collar or one-piece abutment with an externally threaded male projection or a two-piece abutment retained by an externally-threaded fixation screw.

Inside this passage, below the lead-in bevel, may be a wrench-engaging surface/structure, such as a hex-shaped, multi-lobed or slotted surface/structure, to engage an insertion tool and male projections of abutments, configured to fit into the wrench-engaging surface/structure.

Below the internal wrench-engaging surface, inside the passage, is a second beveled portion, forming an angle substantially smaller than the angle of the lead-in bevel, as measured from the implant's vertical centerline. This second bevel is mated with a bevel on the post/abutment/other insert having a slightly greater angle, as measured from the implant's vertical centerline, or a straight extension such that full seating of the abutment on the first bevel forms an interference fit connection, with the second bevel requiring force to fully seat the post/abutment/insert.

For example, the lead-in bevel of the implant may be at an angle of about 44.5 degrees and the mating angle of the insert/abutment, about 45.5 degrees, both angles plus or minus 0.5 degrees, as measured from the implant's vertical centerline. This structure assures that the first contact upon seating the insert/abutment in the implant will be at the opening to the internal shaft/passage. The implant's second bevel can be about 1.5 degrees and is configured, upon full seating of an insert/abutment into the implant, to frictionally engage with a straight or beveled extension on the abutment, adequate to assure an interference fit for frictional retention of an abutment in an implant upon applying about, say, 10-30 Ncm of torque to the fixation screw to achieve full seating of the insert/abutment in the implant.

Below the second beveled portion is a threaded passage portion configured to engage the threaded shank of a 1-piece abutment or a fixation screw used to retain a 2-piece abutment, as shown in FIG. 6, on the implant.

### BRIEF DESCRIPTION OF THE DRAWINGS

An exemplary embodiment of the invention is described in the following detailed description of the drawings, in which:

FIG. 1 is an elevation view of an exemplary embodiment of an implant of this invention, with an abutment in place atop the implant, shown in vertical cross-section;

FIG. 2 is an elevation view of the implant of FIG. 1;

FIG. 3 is a detail view of the internal passage in the abutment, showing a threaded region configured to permit removal of the abutment from an internal passage of an implant; and

FIG. 4 shows insertion of an abutment removal tool into engagement with the threaded region shown in FIG. 3;

FIG. 5 shows the beginning of abutment removal from the implant shown in FIG. 4; and

FIG. 6 shows another exemplary embodiment of an implant of this invention.

### DETAILED DESCRIPTION OF THE DRAWINGS

The drawings show an exemplary, non-limiting embodiment 10 of the new dental implants. Implant 10 includes tapered body portion 11. Body portion 11 is externally threaded, includes threads 12 along its length, and is tapered along its length, below smooth, cylindrical-shaped neck portion 21. Body portion 11 includes vertical groove 19 that facilitates self-tapping insertion of implant 10 in the jawbone of a patient.

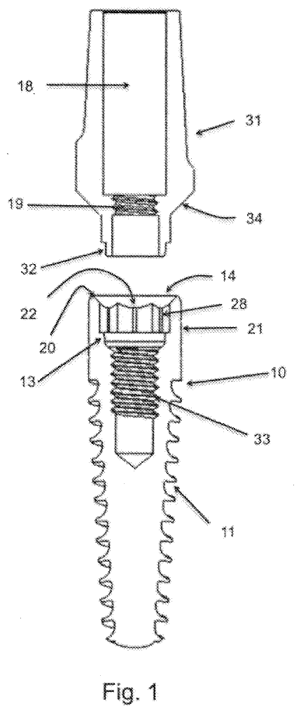

Inside implant 10, as FIGS. 1 and 3 show, is passage 14, with its opening 20 at the top 17 of neck portion 21. Inside opening 20, on the surface of the passage, is beveled, circumferential surface 22. This beveled, circumferential surface/lead-in bevel 22 measures about 44 degrees with respect to implant 10's centerline.

Below beveled surface 22 is wrench-engaging surface/structure 28, a hex-shaped surface to receive and engage a tool of complementary shape and size to screw, or otherwise place, implant 10 into the jawbone of a patient.

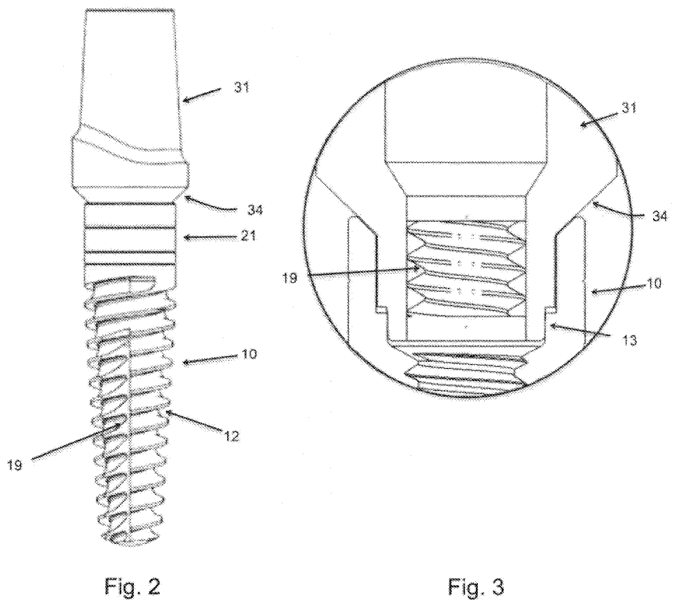

Below wrench-engaging surface 28 is second beveled surface 13. Second beveled surface 13 measures about 1.5-degrees (+/−0.5 degrees) with respect to implant 10's center line, and is configured to engage a 1.5-2.5 degree (+/−0.5 degrees) bevel 32 on abutment 31, forming a frictional fit called a Morse Taper connection, or an interference fit, once abutment 11 is inserted into passage 14 of implant 10 as shown in FIGS. 2 and 3.

Below second beveled surface 13 is threaded passage portion 33, configured to threadedly engage a threaded shank on a retention screw that passes vertically through a vertical passage 18 in abutment 31, from the top of the abutment, and secures abutment 31 in place atop implant 10.

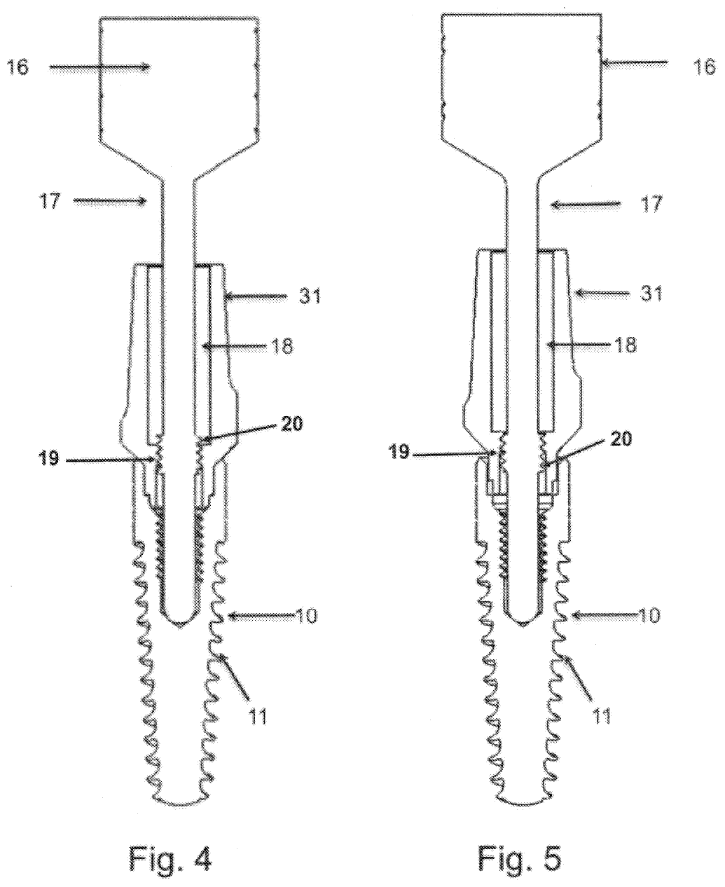

As shown in FIGS. 1 to 5, abutment 31 includes wrench-engaging surface 31A, that is configured to mate with wrench-engaging surface 28, a bevel 34 that mates with beveled surface 22 and a passage 18, with a threaded region 19A configured to engage tool 16. Tool 16 includes shaft 17 with a threaded region 20A near its midsection. Threaded region 20A is configured to threadedly engage threaded region 19A and, upon turning of tool 16, to remove abutment 11 from implant 10.

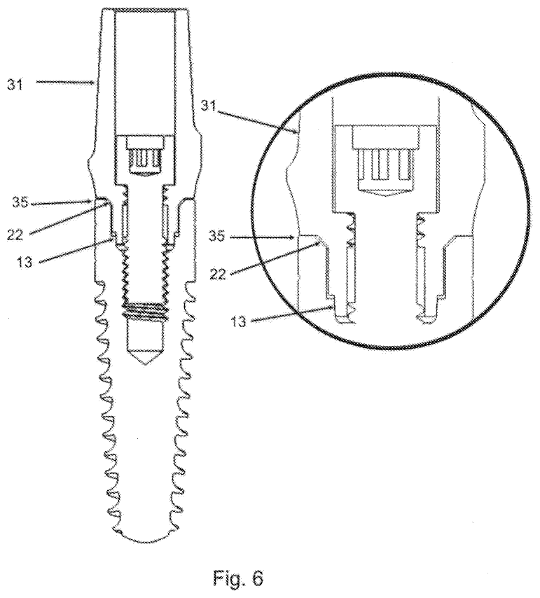

FIG. 6 shows abutment 31 seated atop implant 10. Lead-in bevel 22 on implant 10 does not engage corresponding bevel on abutment 31. But, second bevel 13 inside implant 10 does frictionally engage second bevel 32 on abutment 31. In this exemplary configuration, abutment 31 seats on top surface of implant 10 at interface 35.

1. An externally-threaded dental implant including an internal, threaded passage with a vertical centerline and a proximal opening into said internal, threaded passage that includes, near the opening into said internal, threaded passage, a lead-in bevel, configured to accept insertion, into said internal, threaded passage, of a post/abutment/insert that includes a bevel configured to mate with said lead-in bevel; below said lead-in bevel in said dental implant, a wrench-engaging surface configured to accept insertion, of a post/abutment/insert that includes a mating wrench-engaging surface; below said wrench-engaging surface, inside said internal, threaded passage, a second beveled surface having a bevel angle substantially smaller than said lead-in bevel, measured with respect to said vertical centerline of said implant, said second beveled surface configured to accept a post/abutment/insert with a distal extension configured to form an interference connection, between said distal extension on said post/abutment/insert and said second beveled surface, said interference connection resulting from a force, in the range of 5 to 30 Newton-centimeters, applied to a fixation screw, used to retain said post/abutment/insert on said implant, sufficient to seat the bevel of said post/abutment/insert on said lead-in bevel, thereby creating a stable connection.

2. The dental implant of claim 1, wherein said lead-in bevel is configured to accept insertion, into said internal, threaded passage, of a post/abutment/insert with a bevel about 1 degree larger than said implant's lead-in bevel, as measured from the implant's vertical centerline, and providing implant/post/abutment/insert contact substantially at the opening to said internal threaded passage.

3. The dental implant of claim 2, wherein said lead-in bevel on said implant is about 44.5 degrees, plus or minus 0.5 degree, and the mating bevel on the post/abutment/insert is about 45.5 degrees, plus or minus 0.5 degree, both measured from said implant's vertical centerline.

4-11. (canceled)

12. The post/abutment/insert of claim 17, wherein said lead-in bevel is about 44.5 degrees, plus or minus 0.5 degree, and its mating bevel on the post/abutment/insert is about 45.5 degrees, plus or minus 0.5 degree, both measured from said implant's vertical centerline.

13-15. (canceled)

16. The post/abutment/insert of claim 17, further comprising a threaded internal passage configured to engage a tool for removal of said post/abutment/insert from said dental implant.

17. A post/abutment/insert, said post/abutment/insert configured for retention on an implant by a fixation screw that engages an internal, threaded passage inside said implant, said post/abutment/insert including a first bevel configured to seat on a lead-in bevel of said implant, a wrench engaging surface configured to seat on a wrench-engaging surface of said implant, and a distal extension configured to form an interference connection between said distal extension on said post/abutment/insert and a second bevel located below said implant's wrench-engaging surface inside said internal threaded passage of said implant, said interference connection resulting from a force, in the range of 5 to 30 Newton-centimeters applied to said fixation screw, to retain said post/abutment/insert on said implant, and sufficient to seat said first bevel of said post/abutment/insert on said lead-in bevel, thereby creating a stable connection.
